(19) United States
(12) Patent Application Publication
(10) Pub. No.: US 2026/0197919 A1
(43) Pub. Date: Jul. 9, 2026

(54) A METHOD OF AND A COMPUTING DEVICE FOR ADAPTING HOLD-ON TIME OF A LIGHTING DEVICE DEPLOYED WITHIN A SPATIAL LOCATION

(71) Applicant: SIGNIFY HOLDING B.V., EINDHOVEN (NL)

(72) Inventors: CHUN YANG, SHANGHAI (CN); GANG WANG, SHANGHAI (CN); GONGMING WEI, SHANGHAI (CN); JIA LONG QUI, SHANGHAI (CN)

(21) Appl. No.: 19/132,053

(22) PCT Filed: Nov. 20, 2023
(86) PCT No.: PCT/EP2023/082383

§ 371 Date: May 22, 2025

(30) Foreign Application Priority Data
Nov. 25, 2022 (WO) PCT/CN2022/134456
Feb. 10, 2023 (EP) 23155951.9

(51) Int. Cl. H05B 47/115; G01S 13/56; G01S 13/88

(52) U.S. Cl. CPC H05B 47/115; G01S 13/56; G01S 13/88

(57) ABSTRACT

A method of adapting hold-on time of at least one lighting device deployed within a spatial location is disclosed. The method comprises the steps of: determining occurrence of an event specifically associated with the spatial location by detecting an activity of one or more objects involved in the event based on sensing data of the spatial location obtained by a radar sensor; deciding a type of the spatial location based on the occurrence of the event specifically associated with the spatial location; and adapting the hold-on time of the at least one lighting device deployed within the spatial location based on the decided type of the spatial location.

### TECHNICAL FIELD

The present disclosure generally relates to the field of lighting control, more particularly, to a method of and a computing device for adapting hold-on time of a lighting device deployed within a spatial location.

### BACKGROUND

In the area of lighting control, it is known to support or render different lighting based on various conditions which are detectable using sensing devices or configurable by a user. As an example, a lighting device may be switched on and off based on presence of a target, such as a person or a vehicle, detected by way of a presence sensor such as a motion sensor.

With the development of smart lighting technologies, more and more consumers are bringing smart lighting into more spaces of their homes such as kitchens and washrooms. For a room deployed with a lighting device supporting the light-on-demand function, the lighting device can turn on automatically when a person enters the room. Moreover, the lighting device can also turn off automatically after the person goes away and the room is kept vacant for a pre-defined duration. This duration between the person leaving and the lighting device being switched off or entering standby is referred to as a hold-on time of the lighting device.

It is known that the period of hold-on time may be different for lighting devices deployed at different locations. As an example, the hold-on time for lighting device, such as a panel light, installed in a kitchen is different from the hold-on time of a panel light installed in a washroom.

This is due to that a user of the kitchen might leave the kitchen and come back shortly. Too short of a hold-on time for the lighting device in the kitchen will cause frequent on/off of the light device, which may lead to bad user experience.

A user of the washroom or bathroom, on the contrary, once leaves, will not come back in a short period of time. As a result, the hold-on time for a lighting device installed in the washroom can be set to as short as for example several seconds. This is in line with the habit and/or expectation of users as people usually turn off the light before leaving the washroom.

In a smart home scenario, hold-on times of lighting devices at different locations or rooms may be configured during commissioning of the lighting devices via for example a mobile application. However, in reality all consumers are not willing or able to do the commissioning.

Moreover, some entry-level lighting products do not actually support commissioning after installation as these products are non-IoT products.

In consideration of the above, it is desirable that a method of automatically adapting hold-on time of a lighting device deployed within a spatial location is available.

### SUMMARY

In a first aspect of the present disclosure, there is presented a method of adapting hold-on time of at least one lighting device deployed within a spatial location, comprising the steps of:
determining occurrence of an event specifically associated with the spatial location by detecting an activity of one or more objects involved in the event based on sensing data of the spatial location obtained by a radar sensor;
deciding a type of the spatial location based on the occurrence of the event specifically associated with the spatial location; and
adapting the hold-on time of the at least one lighting device deployed within the spatial location based on the decided type of the spatial location.

The present disclosure is based on the insight that a type of a spatial location having a lighting device deployed therein may be determined or decided by detecting occurrence of an event specifically associated with the spatial location, which can be used to adapt a hold-on time of the lighting device installed in the spatial location.

It is known that events involving activities of both human beings and objects may take place in a spatial location. While the activities of human beings may be similar for different spatial locations, activities of objects that take place during the event may be specifically associated with or even unique to the spatial location. Therefore, the event specifically associated with the spatial location can be detected by recognizing or detecting the activity of one or more objects involved in the event, using a radar sensor deployed in the spatial location.

Based on this insightful idea, sensing data of the spatial location captured or obtained by the radar sensor is used to determine the occurrence of an event specifically associated with the spatial location. As the occurrence of the event is specifically associated with the spatial location, the determination of the occurrence of the event allows a type of the spatial location to be decided. Based on the type of the spatial location, the hold-on time of a lighting device deployed in the spatial location is adapted accordingly, by making it for example shorter or longer than the default value.

The method of the present disclosure therefore allows the hold-on time of lighting devices deployed in different spatial locations to be adapted automatically without the interference of the user. It can provide better user experience and may lead to saving in energy consumptions for some spatial locations.

In an example of the present disclosure, the step of determining occurrence of an event specifically associated with the spatial location comprises the steps of:
obtaining a spectrogram representation of the sensing data of the spatial location by applying a transform algorithm to the sensing data;
identifying, in the spectrogram representation, a signal pattern, e.g., an energy distribution pattern within predetermined frequency ranges, representing the activity of one or more objects involved in the event; and
determining that the event specifically associated with the spatial location is present.

A spectrogram representation is a visual representation of a spectrum of frequencies of a signal as it varies with time. The spectrogram representation of the sensing data of the spatial location captured by the radar sensor may be obtained via a transform algorithm. Different spectrum patterns may be recognized from the obtained spectrogram representation, including those representing the activity of one or more objects involved in the event that is specifically associated with the spatial location.

When such a signal pattern is identified, it can be determined that the event specifically associated with the spatial location has occurred or been present.

Algorithms for obtaining the spectrogram representation of the sensing data are known and can be easily adopted by the present disclosure.

In an example of the present disclosure, the occurrence of the event specifically associated with the spatial location is determined with further reference to detecting presence of a person based on the sensing data of the spatial location.

As can be easily understood by those skilled in the art, the occurrence of an event mostly also involves the presence of a human being. Therefore, the occurrence of the event specifically associated with the spatial location may be determining in a more accurate manner by taking into consideration the presence of the human being.

It is to be noted that the step of deciding a type of a spatial location based on the occurrence of the event specifically associated with the spatial location is actually an intermediate step.

The essential point of the invention is to set different hold-on time for light devices depending on occurrence of different activities detected by a radar sensor via identifying an energy distribution pattern within predetermined frequency ranges.

A method of adapting hold-on time of at least one lighting device could include the following steps as:
obtaining a spectrogram representation of sensing data obtained by a radar sensor by applying a transform algorithm to the sensing data;
identifying, in the spectrogram representation, an energy distribution pattern within predetermined frequency ranges representing the activity of one or more objects involved in an event; and
adapting the hold-on time of the at least lighting device based on the identified energy distribution pattern.

In an example, the hold-on time of the lighting devices could be determined based on two or more different energy patterns identified in the spectrogram representation of sensing data.

The hold-on time of a lighting device may be referred to as a timeout value of a lighting device, it is a duration between no occupant being detected and the lighting device being switched off or entering standby mode, or dimming down.

In an example of the present disclosure, detecting presence of a person based on the sensing data of the spatial location is performed with reference to the spectrogram representation of the sensing data.

The obtained spectrogram representation of the sensing data may also be conveniently used for detecting the presence of a person or a human being. The detection method is known to those skilled in the art and will not be elaborated here.

In an example of the present disclosure, the transform algorithm is a Fast Fourier Transform, FFT.

FFT is a well-established algorithm for converting a signal from the time domain to the frequency domain. It can be easily used to obtain the spectrogram representation of the sensing data of the spatial location obtained by the radar sensor, without requiring much further developing efforts.

In an example of the present disclosure, the event specifically associated with the spatial location comprises a person flushing a toilet, the step of identifying a signal pattern representing the activity of one or more objects involved in the event comprises:
identifying, from the spectrogram representation, a second energy distribution pattern, representing motion of water inside the toilet, within a frequency range between zero hertz and a first threshold frequency in a second time period following a first time period having a first energy distribution pattern representing motion of the person, the first threshold frequency being in a range of one hertz to a dozen hertz, depending on the operating frequency of the radar sensor.

It is recognized by the inventor that a special energy distribution pattern, generated by water refilling or flowing into the toilet after flushing the toilet, will be present in the spectrogram representation of the sensing data obtained by the radar sensor, when the event is a person flushing the toilet. Therefore, the identification of such a pattern can be used to decide the type of the spatial location.

The special energy distribution pattern comprises waveform in the range of zero hertz to for example about ten hertz, for a radar sensor operating at 5.8 GHz. It may be up to a dozen hertz, depending on the operating frequency of the radar sensor.

Such a special energy distribution pattern, combining with a first energy distribution pattern which is associated with the motion of a person, leads to the identification or determination of the event that is specifically associated with the spatial location, in this case a toilet. Thereafter, the hold-on time of the spatial location can be adapted based on the location.

In an example of the present disclosure, the event specifically associated with the spatial location comprises a person taking a shower, the step of identifying a signal pattern representing the activity of one or more objects involved in the event comprises:
identifying, from the spectrogram representation, an evenly-distributed energy pattern, representing motion of water during showering, over a frequency range from zero hertz to a second threshold frequency superimposed on a first energy distribution pattern representing motion of the person, the first energy distribution pattern being present in a first time period and a second time period following the first time period, the evenly-distributed energy pattern being present only in the second time period, the second threshold frequency being in a range of a couple of hundred hertz to a thousand hertz, depending on the operating frequency of the radar sensor.

Similarly, a special energy distribution pattern is also recognizable for an event comprising a person taking a shower. When such a pattern is identified in combination with a pattern which is associated with the motion of a person, it can be decided that an event that is specifically associated with the spatial location, in this case a bathroom, has occurred. Thereafter, the hold-on time of the spatial location can be adapted based on the location.

In a further example of the present disclosure, the event specifically associated with the spatial location comprises a ventilator being turned on, the step of identifying a signal pattern representing the activity of one or more objects involved in the event comprises:
identifying, from the spectrogram representation, an energy distribution pattern representing boot of ventilator having a plurality of frequency components with their respective peak frequencies linearly increasing from zero hertz and becoming stable simultaneously in terms of both the peak frequency and energy of the peak frequency, the plurality of frequency components being multiples of a base frequency, the energy distribution pattern being present in a second time period following a first time period having a first energy distribution pattern representing motion of a person, the base frequency dependent on the operating frequency of the radar sensor.

In still a further example of the present disclosure, the event specifically associated with the spatial location comprises a ventilator being turned off, the step of identifying a signal pattern representing the activity of one or more objects involved in the event comprises:
identifying, from the spectrogram representation, an energy distribution pattern representing shutdown of ventilator having a plurality of frequency components with their peak frequencies linearly decreasing and disappearing simultaneously, the plurality of frequency components being multiples of a base frequency, in the second time period following the first time period having a first energy distribution pattern representing motion of a person, the base frequency dependent on the operating frequency of the radar sensor.

The two events of the above examples respectively relate to a ventilator being turned on and off. Each of the events is associated with a special energy distribution pattern in the spectrogram representation, which can be used to determine or identify the occurrence of the event. The occurrence of the event is translated to the decision as to the type of the spatial location, and hold-on time of the lighting device deployed in the spatial location may be then adapted automatically.

In an example of the present disclosure, the step of deciding comprises deciding a type of the spatial location to be a bathroom or a toilet, and the step of adapting comprises changing the hold-on time of the at least one lighting device to a time period shorter than an original configured time period.

For the above described examples, the occurrence of the different events allows a device performing the method of the present disclosure to decide that the spatial location comprises a toilet or a bathroom. As such locations normally require shorter hold-on time, the originally configured hold-on time period is adapted to a shorter one. This will render better user experience and lead to energy saving.

In an example of the present disclosure, the method further comprising, prior to the step of deciding, a step of:
determining an occurrence frequency of the events specifically associated with the spatial location, based on the sensing data of the spatial location;
the step of deciding is performed further with reference to the determined occurrence frequency of the activity of the one or more objects.

It can be contemplated by those skilled in the art an event specifically associated with a spatial location may happen more or less often, depending on the type of the spatial location. As an example, cooking may happen one to three times a day, while flushing the toilet may happen more often during the day. Therefore, the occurrence frequency of the events specifically associated with the spatial location may also be considered in deciding the type of the spatial location, such that a more accurate result is achieved.

In an example of the present disclosure, the method further comprising, prior to the step of deciding, a step of:
determining a time sequence of a plurality of events specifically associated with the spatial location, based on the sensing data of the spatial location;
the step of deciding is performed further with reference to the determined time sequence of the plurality of activities of the of the one or more objects.

It can be contemplated by those skilled in the art that several events specifically associated with the spatial location may happen according to a specific order. As an example, a person, when using the toilet, may switch on the ventilator first, use and flush the toilet, and then switch off the ventilator. Therefore, the time sequence of a plurality of events specifically associated with the spatial location may also be helpfully considered in deciding the type of the spatial location.

In an example of the present disclosure, the radar sensor is integrated into at least one lighting device deployed within the spatial location.

Some lighting devices, like a panel luminaire, have radar sensors integrated in the lighting devices for enabling more advance applications. Such radar sensors may be used to measure the sensing data used in the method of the present disclosure conveniently.

A second aspect of the present disclosure provides a processing system arranged for performing the method according to the first aspect of the present disclosure.

The method may be performed by a computing device or a processing system such as a server supporting all the smart home applications.

A third aspect of the present invention disclosure provides a lighting system comprising a processing system in the second aspect, a radar sensor and a light device; wherein hold on time of the light device is adapted by the processing system based on the sensing data obtained by the radar sensor.

A fourth aspect of the present disclosure provides a computer program product, comprising a computer readable storage medium storing instructions which, when executed on at least one processor, cause said at least one processor to carry out the method according to the first aspect of the present disclosure.

The above mentioned and other features and advantages of the disclosure will be best understood from the following description referring to the attached drawings. In the drawings, like reference numerals denote identical parts or parts performing an identical or comparable function or operation.

### BRIEF DESCRIPTION OF THE DRAWINGS

FIG. 1 schematically illustrates exemplary spatial locations having lighting devices deployed therein.

FIG. 2 schematically illustrates, in a flow chart type diagram, an embodiment of a method of adapting hold-on time of a lighting device deployed in a spatial location in accordance with the present disclosure.

FIG. 3 schematically illustrates, in a flow chart type diagram, exemplary steps of determining occurrence of an event specifically associated with the spatial location, in accordance with the present disclosure.

FIG. 4 illustrates sensing data and spectrogram representation thereof of an event of flushing a toilet.

FIG. 5 illustrates sensing data and spectrogram representation thereof of an event of a user taking a shower.

FIG. 6 illustrates sensing data and spectrogram representation thereof of an event of switching a ventilator on.

FIG. 7 illustrates sensing data and spectrogram representation thereof of an event of switching a ventilator off.

FIG. 8 schematically illustrates signals collected by a radar sensor for realizing location awareness by the radar sensor.

### DETAILED DESCRIPTION

Embodiments contemplated by the present disclosure will now be described in more detail with reference to the accompanying drawings. The disclosed subject matter should not be construed as limited to only the embodiments set forth herein. Rather, the illustrated embodiments are provided by way of example to convey the scope of the subject matter to those skilled in the art.

Hold-on time of the lighting device as used in the present disclosure refers to a duration between a user or a person leaving a spatial location and a lighting device deployed in the spatial location being switched off or entering standby. Those skilled in the art will appreciate that this time period may be named differently but refers to the same concept of hold-on time used herein.

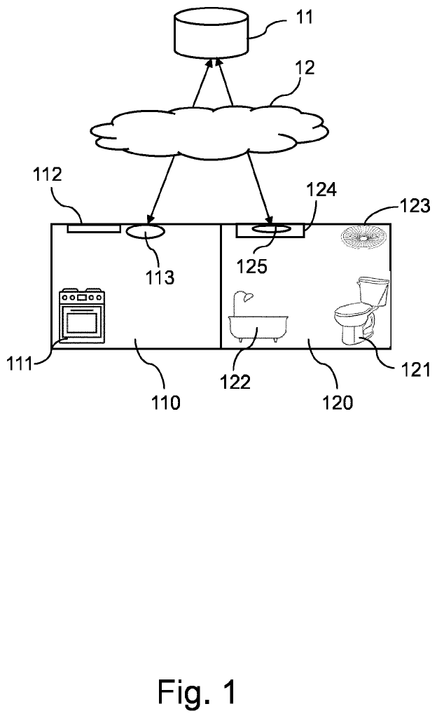

FIG. 1 schematically illustrates exemplary spatial locations having lighting devices deployed therein. The hold-on time of the lighting devices may be adapted according to the method of the present disclosure.

FIG. 1 illustrates a kitchen 110 and a bathroom 120. An oven 111, a lighting device 112 and a radar sensor 113 are provided or deployed in the kitchen 110. The bathroom 120 has a toilet 121, a bathtub 122, a ventilator 123, a lighting device 124 and a radar sensor 125 deployed therein.

The lighting device 112 and the radar sensor 113 of the kitchen 110 are illustrated as separate devices, while the lighting device 124 in the bathroom 120 is illustrated as being integrated with the radar sensor 125. It can be understood by those skilled in the art the radar sensor may or may not be provided in the lighting device, depending on the specific lighting device that is being used. The inventive idea of the present disclosure is applicable to both scenarios. Moreover, the lighting device used is not limiting to the present disclosure.

The radar sensor 113 and 125 may be a radar sensor available from the market, such as a 5.8 GHz doppler radar. The present disclosure is not limited to any specific type of radar sensors.

Both the radar sensors 113 and 125 are communicatively connected to a computing device 11, via for example the internet 12. The computing device 11 may be deployed remotely, such as at the backend or on the cloud, or locally.

Each radar sensor 113 and 125 respectively monitors the spatial location where it is installed, that is, the kitchen 110 and the bathroom 120, and obtains sensing data on motions of human beings and objects in the spatial location. The obtained sensing data is communicated or transmitted to the computing device 11 via for example the internet 12.

In the following, a method of adapting hold-on time of a lighting device, such as the lighting device 112 and 124, will be described.

The present disclosure proposes to use a radar sensor, such as a radar sensor integrated in a lighting device like a panel luminaire, to determine a type of a spatial location having the lighting device installed therein, and then to adapt hold-on time of the lighting device accordingly.

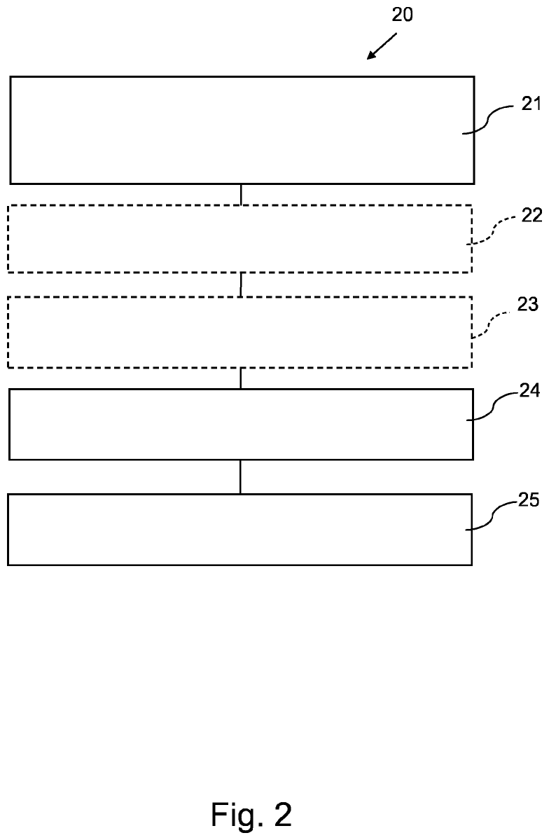

FIG. 2 schematically illustrates, in a flow chart type diagram, an embodiment of a method 20 of adapting hold-on time of a lighting device deployed in a spatial location in accordance with the present disclosure.

At step 21, occurrence of an event specifically associated with the spatial location is determined by detecting an activity of one or more objects involved in the event based on sensing data of the spatial location obtained by a radar sensor.

The radar sensor is installed in the same spatial location as the lighting device and constantly monitors the spatial location to obtain or capture sensing data representing events taking place in the spatial locations.

As can be contemplated by those skilled in the art, events involving activities of both human beings and objects may take place in a spatial location. While the activities of human beings may be similar for different spatial locations, activities of objects that take place during the event may be specifically associated with or even unique to a spatial location.

As an example, events specifically associated with a washroom or a bathroom may comprise a person flushing a toilet, showering, turning on or off a ventilator. Flushing the toilet, as an example, always involves an activity of water refilling the empty water tank, following the toilet being flushed.

Therefore, when the activity of water refilling the water tank is detected, it is determined that the event of flushing the toilet has occurred.

Next, at step 24, a type of the spatial location is decided or determined based on the occurrence of the event specifically associated with the spatial location.

As an example, the water refilling the water tank is used to determining the event of flushing the toilet. As the event of flushing the toilet is specifically associated with a bathroom or toilet, it can be decided that the spatial location is a bathroom or a toilet.

It can be contemplated by those skilled in the art that an event happening in a spatial location may take place several times during a certain time period. As an example, cooking may happen one to three times a day, while flushing the toilet may happen more often during the day. Therefore, at step 22, the occurrence frequency of an event specifically associated with a spatial location may optionally also be determined. The occurrence frequency may be taken into consideration when deciding the type of the spatial location.

Moreover, several events taking place in a spatial location may happen according to a specific sequence. As an example, when using a toilet, the user first enters the toilet, then the ventilator is switched on, followed by flushing the toilet, and subsequently switching the ventilator off. Therefore, at step 23, the time sequence of a plurality of events specifically associated with a spatial location may also be determined, which may then be considered when making the decision as to the type of the spatial location at step 24.

At step 25, the hold-on time of a lighting device deployed within the spatial location is adapted based on the decided type of the spatial location.

This is realized taking into consideration of user habits and expectations. As an example, the hold-on time of a lighting device deployed in a toilet may be adapted to be shorter than a preconfigured hold-on time as the user normally will not return to the toilet shortly after using the toilet.

As another example, the hold-on time of a lighting device deployed in a kitchen may be adapted to be longer than a preconfigured hold-on time as the user may leave and then come back to the kitchen very soon, as a result of for example fetching something needed for cooking.

The determination of the occurrence of an event specifically associated with the spatial location is performed with reference to a spectrogram representation of the sensing data of the spatial location, which will be detailed later in the description.

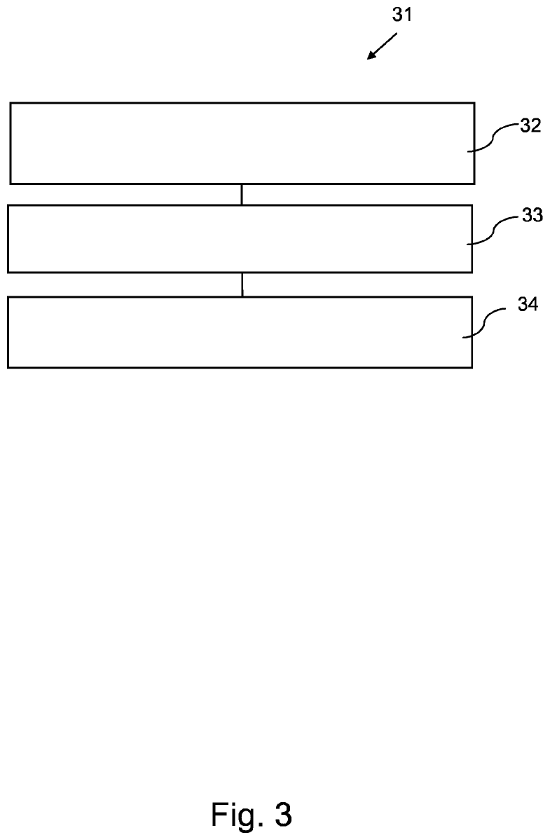

FIG. 3 schematically illustrates, in a flow chart type diagram, exemplary steps of determining 31 occurrence of an event specifically associated with the spatial location, in accordance with the present disclosure.

At step 32, a spectrogram representation of sensing data of spatial location is obtained by applying a transform algorithm to the sensing data.

The transform algorithm may be for example Fast Fourier Transform, which can be conveniently used to transform the sensing data from the time domain to the frequency domain.

At step 33, a signal pattern representing the activity of one or more objects involved in the event is identified in the spectrogram representation.

With reference to the above example of the event of flushing the toilet, a pattern specially representative of the activity of water refilling the water tank can be identified, which will be detailed in the following.

At step 34, it is determined that the event specifically associated with the spatial location has occurred or been present.

In the above example, when identifying the pattern specially representative of the activity of water refilling the water tank, it can be determined that the event of flushing the toilet has occurred.

Several examples of determining the occurrence of an event specifically associated with a spatial location will be described in the following.

In the case of a bathroom or a toilet, a radar sensor, such as a 5.8 GHz Doppler Radar sensor may be used to detect events specifically associated with this space, comprising for example, flushing a toilet, taking a shower, turning on or off a ventilator.

In the case of a kitchen, a radar sensor may be used to detect events specifically associated with the kitchen, comprising for example an oven baking something, a dishwasher running, boiling food and so on.

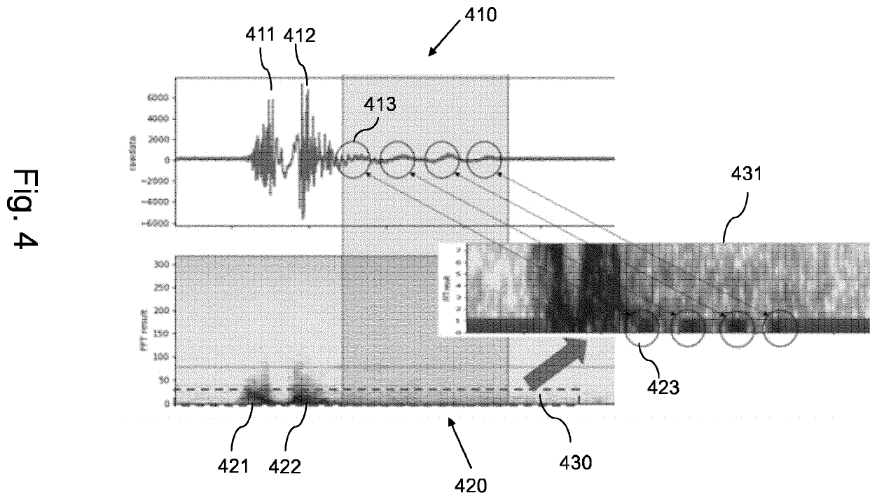

FIG. 4 illustrates sensing data and spectrogram representation thereof of an event of flushing a toilet.

Graph 410 in the upper part of FIG. 4 is raw data comprising the event of flushing the toilet, captured by a radar sensor installed in the toilet. Graph 420 in the lower part of FIG. 4 is a FFT result or spectrogram representation of the raw data of graph 410.

In the raw data 410, a cluster of signals indicated by a numeral 411 represents an activity of a person entering the toilet, which in the spectrum domain is represented by an energy pattern 421.

In the raw data 410, a cluster of signals indicated by a numeral 412 represents an activity of a person leaving the toilet, which in the spectrum domain is represented by an energy pattern 422.

An enlarged view 431 of a part of the spectrogram representation indicated by a dashed rectangle 430 is shown in FIG. 4. Ripples indicated by circles 413 in the raw data 410 represents an activity of a water tank being refilled after flushing the toilet, which is represented as energy patterns indicated by a numeral 423 in the enlarged view 431.

The raw radar data or signal 410 as well as the spectrogram representation 420 of the raw data illustrate an event of user flushing the toilet. Refereeing to the above description, FIG. 4 shows an activity of the user first entering the toilet 411, 412, an activity of the user leaving (after flushing the toilet) 412, 422 and an activity of the water tank being refilled 413, 423.

A very specific or even unique signal pattern is generated by the water flushing and flowing into the water tank. For a 5.8 GHz radar sensor, a very slow waveform with less than 1 Hz frequency reflects the refilling very well. When the radar operates at a higher frequency, an upper limit of the pattern reflecting the refilling procedure is higher.

The detection of motions from the user comprising entering (optionally also leaving) and motions of water flow, that is, water quickly flowing from the tank to the bowl, slowly flowing to refill the tank, confirms the event of flushing the toilet.

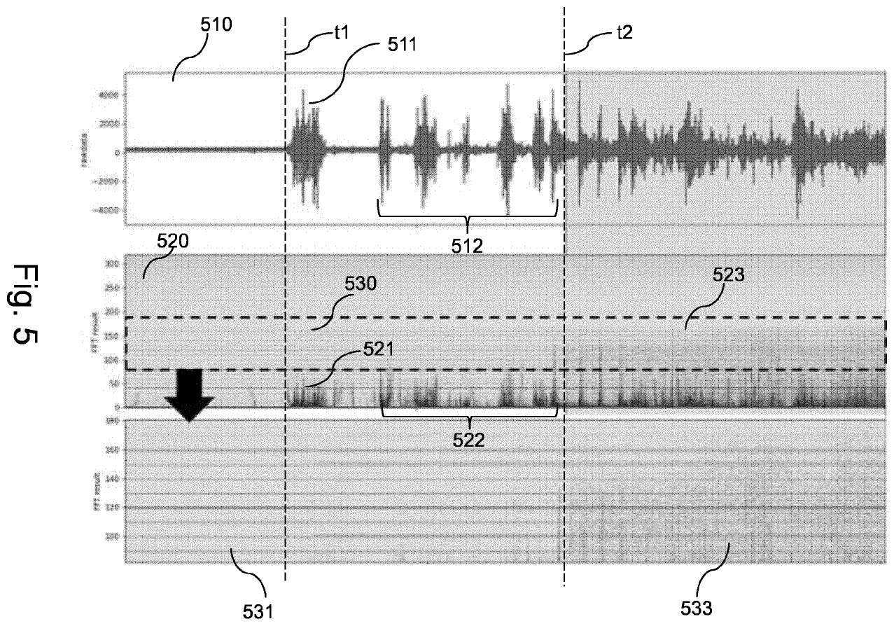

FIG. 5 illustrates sensing data and spectrogram representation thereof of an event of a user taking a shower.

Graph 510 in the upper part of FIG. 5 is raw data comprising the event of a user taking a shower, captured by a radar sensor installed in the bathroom. Graph 520 in the middle part of FIG. 5 is a FFT result or spectrogram representation of the raw data of graph 510.

An enlarged view of energy distribution in a frequency range indicated by a dashed rectangle 530 is illustrated in graph 531 at the lower part of FIG. 5.

In FIG. 5, both the raw data and the spectrogram representation before a time point indicated by a dashed line t1 represent a vacant bathroom. From the time point t1, a user enters the bathroom and starts to prepare for the showering, till a time point indicated by a dashed line t2.

The activity of the user entering the bathroom may be detected by the radar sensor as a big motion represented by a cluster of signals 511 in the time domain and an energy pattern 521 in the frequency domain.

Activities performed by the user during the preparation for the shower indicated by signals 512 are represented in the frequency domain as mainly focusing in a low-frequency range, which is also easily detected as big motion 522.

When the preparation finishes and the user turns on the shower head, the water sprinkles out from the shower head. Besides the big motions from user showering, there is an evenly distributed FFT energy increase over the whole frequency range from 0 Hz to more than 150 Hz. Note here the radar sensor operates at 5.8 GHz.

The evenly distributed FFT energy 523, 533 is caused by the doppler effect from sprinkle of water. This types of diffuse pattern over a wide range of FFT frequency is a very special signal pattern and can be detected via a sensing algorithm.

The detection of motions from the user including entering, preparing, showering, (and leaving) and motions of water flow comprising sprinkle from the shower head during showering, via identification of the relevant energy patterns in the spectrogram representation, confirms the event of taking a shower.

As taking a shower is specifically associated with the bathroom, it may determine that the spatial location is a bathroom.

Very often the toilet of bathroom is also equipped with a ventilator. An activity of turning on/off of the ventilator may be identified as a further special or representative signal pattern in the frequency domain.

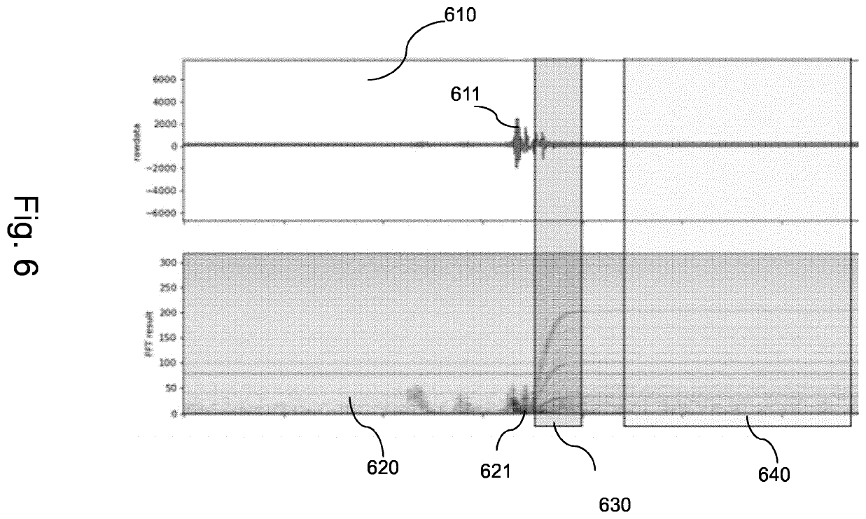

FIG. 6 illustrates sensing data and spectrogram representation thereof of an event of switching a ventilator on.

Graph 610 in the upper part of FIG. 6 is raw data comprising the event of a switching a ventilator on, captured by a radar sensor installed in the bathroom. Graph 620 in the lower part of FIG. 6 is a FFT result or spectrogram representation of the raw data of graph 610.

In FIG. 6, an activity of a user entering the bathroom is detected by the radar sensor as a big motion 611, which is reflected as an energy pattern 621 in the frequency domain.

When the user turns on the ventilator, a very special signal pattern is present in the spectrogram representation 620. When the ventilator starts to work, indicated as a solid line square 630 in FIG. 6, there are lots of frequency components appear and peak frequencies of these frequency components almost linearly increase. When the operation of the ventilator gets stable after a while, indicated as a solid line square 640 in FIG. 6, these frequency components also become stable both on the peak frequency value as well as the energy of these frequency peak. Furthermore, these additional frequency components will be almost at the multiplication of certain base frequency.

The identification of such a special energy pattern in the spectrogram representation is translated to the presence of an event specifically associated with the spatial location, in this case the bathroom.

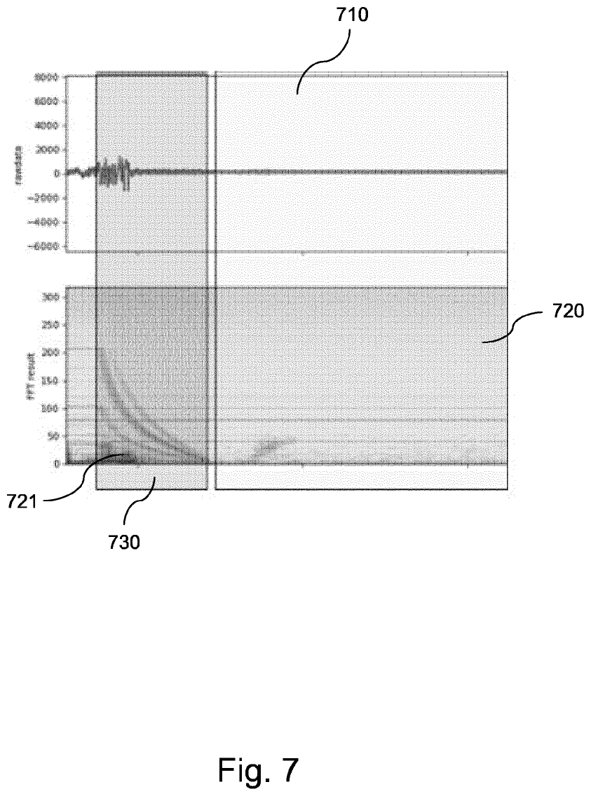

FIG. 7 illustrates sensing data and spectrogram representation thereof of an event of switching a ventilator off.

Graph 710 in the upper part of FIG. 7 is raw data comprising the event of a switching a ventilator off, captured by a radar sensor installed in the bathroom. Graph 720 in the lower part of FIG. 7 is a FFT result or spectrogram representation of the raw data of graph 710.

Before being switched off, the ventilator has been running stably for a while. The presence of a user in the washroom where the ventilator is installed as well as an activity of switching the ventilator off are detected as big motions indicated by an energy pattern 721 in the spectrogram representation.

A very special energy pattern is generated by the ventilator during its power-off. When the ventilator is switched off, it takes time for rotation of the fan and associated vibration induced by the fan to a ceiling to slow down. In the spectrogram representation this is indicated by an almost contradistinctive pattern to the pattern in the switch on process.

In FIG. 7, within the square 730, all frequency components induced by the ventilator and the peak frequencies of these frequency components almost linearly decrease to 0. Eventually disappear once the ventilator completely stops.

The activities of both FIGS. 6 and 7, which correspond to motions from the user (e.g., entering, leaving) and motions of ventilator (start-up, stably operation, slow-down and stop) confirms the event of turning on/off the ventilator.

The above described method of the present disclosure may be implemented via a learning process. The radar sensor can realize location awareness via a learning process after the installation of lighting devices in a spatial location. During the learning process, the radar sensor detects not only motions of users but also events that are specifically associated with the location as described above.

Due to the fact the events are specifically associated the spatial location, in a sense such events exist without the involvement of users, which helps to product more accurate results.

When the spatial location is a bathroom or toilet, during the whole learning process, the radar sensor will do the detection of one or more of these unique events, in combination of the frequency (e.g., flushing toilet happens several times a day) and/or sequence (e.g., turning on the ventilator after taking the showring) of the events, confirms that the radar sensor and the lighting device are installed in the washroom.

When it is decided that the spatial location having the lighting device installed there in, the hold-on time of the lighting device is adapted to a shorter period than the originally configured period. Depending on the decision as the type of the spatial location, the hold-on time of a lighting device may be kept as its default value, or made shorter/longer than the default value.

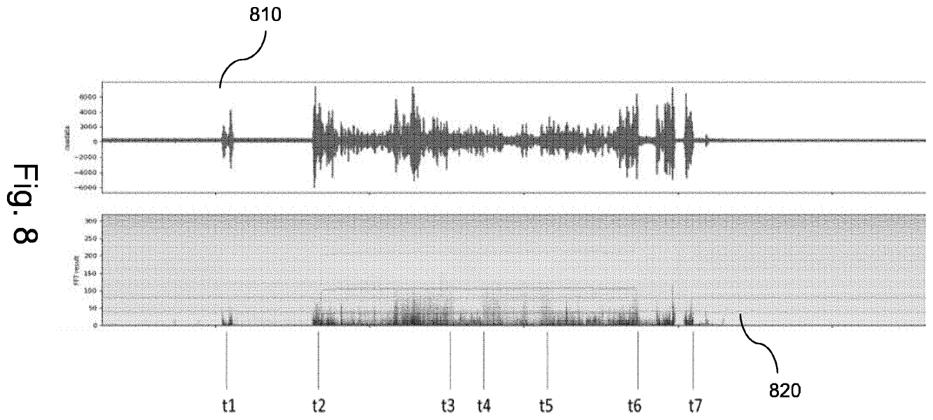

FIG. 8 schematically illustrates signals collected by a radar sensor for realizing location awareness by the radar sensor.

Graph 810 in the upper part of FIG. 8 is raw data comprising various activities happening in a bathroom, captured by a radar sensor installed in the bathroom. Graph 820 in the lower part of FIG. 8 is a FFT result or spectrogram representation of the raw data of graph 810.

The method of the present disclosure may identify the following events from FIG. 8,
1) opening of the shower head at t1 to t3, t4 to t5,
2) Turning on of the ventilator at t2,
3) Turning off the ventilator at t6.

The detection as to the presence or non-presence of other motions may be used to assist deciding the type of the spatial location,
1) Big motion from t2 to t7
2) No motion before t1 and after t7.

With above information, the method of the present disclosure can easily conclude there is someone taking shower within the sensor detection area and its installation confirmed as washroom instead of kitchen.

The present disclosure is not limited to the examples as disclosed above, and can be modified and enhanced by those skilled in the art beyond the scope of the present disclosure as disclosed in the appended claims without having to apply inventive skills and for use in any data communication, data exchange and data processing environment, system or network.

1. A method of adapting hold-on time of at least one lighting device deployed within a spatial location, comprising the steps of:
determining occurrence of an event specifically associated with the spatial location by detecting an activity of one or more non-human objects involved in the event based on sensing data of the spatial location obtained by a radar sensor;
deciding a type of the spatial location based on the occurrence of the event specifically associated with the spatial location; and
adapting the hold-on time of the at least one lighting device deployed within the spatial location based on the decided type of the spatial location,
wherein the step of determining occurrence of an event specifically associated with the spatial location comprises the steps of:
obtaining a spectrogram representation of the sensing data of the spatial location by applying a transform algorithm to the sensing data;
identifying, in the spectrogram representation, an energy distribution pattern within predetermined frequency ranges representing the activity of one or more non-human objects involved in the event; and
determining that the event specifically associated with the spatial location is present;
wherein hold on time comprises a duration between no occupant being detected and the lighting device being switched off or entering standby mode.

2. The method according to claim 1, wherein the occurrence of the event specifically associated with the spatial location is determined with further reference to detecting presence of a person based on the sensing data of the spatial location.

3. The method according to claim 2, wherein detecting presence of a person based on the sensing data of the spatial location is performed with reference to the spectrogram representation of the sensing data.

4. The method according to claim 2, wherein the transform algorithm is a Fast Fourier Transform.

5. The method according to claim 2, wherein the event specifically associated with the spatial location comprises a person flushing a toilet, the step of identifying (S33) a signal pattern representing the activity of one or more non-human objects involved in the event comprises:
identifying, from the spectrogram representation, a second energy distribution pattern representing motion of water inside the toilet within a frequency range between zero hertz and a first threshold frequency in a second time period following a first time period having a first energy distribution pattern representing motion of the person, the first threshold frequency being in a range of one hertz to a dozen hertz, depending on the operating frequency of the radar sensor.

6. The method according to claim 2, wherein the event specifically associated with the spatial location comprises a person taking a shower, the step (S33) of identifying a signal pattern representing the activity of one or more non-human objects involved in the event comprises:
identifying, from the spectrogram representation, an evenly-distributed energy pattern representing motion of water during showering over a frequency range from zero hertz to a second threshold frequency superimposed on a first energy distribution pattern representing motion of the person, the first energy distribution pattern being present in a first time period and a second time period following the first time period, the evenly-distributed energy pattern being present only in the second time period, the second threshold frequency being in a range of a couple of hundred hertz to a thousand hertz, depending on the operating frequency of the radar sensor.

7. The method according to claim 2, wherein the event specifically associated with the spatial location comprises a ventilator being turned on, the step of identifying (S33) a signal pattern representing the activity of one or more non-human objects involved in the event comprises:
identifying, from the spectrogram representation, an energy distribution pattern representing boot of ventilator having a plurality of frequency components with their respective peak frequencies linearly increasing from zero hertz and becoming stable simultaneously in terms of both the peak frequency and energy of the peak frequency, the plurality of frequency components being multiples of a base frequency, the energy distribution pattern being present in a second time period following a first time period having a first energy distribution pattern representing motion of a person, the base frequency dependent on the operating frequency of the radar sensor.

8. The method according to claim 2, wherein the event specifically associated with the spatial location comprises a ventilator being turned off, the step of identifying (S33) a signal pattern representing the activity of one or more objects involved in the event comprises:
identifying, from the spectrogram representation, an energy distribution pattern representing shutdown of ventilator having a plurality of frequency components with their peak frequencies linearly decreasing and disappearing simultaneously, the plurality of frequency components being multiples of a base frequency, in the second time period following the first time period having a first energy distribution pattern representing motion of a person, the base frequency dependent on the operating frequency of the radar sensor.

9. The method according to claim 5, wherein the step of deciding (S24) comprises deciding a type of the spatial location to be a bathroom, and the step of adapting (S25) comprises changing the hold-on time of the at least one lighting device to a time period shorter than an original configured time period.

10. The method according to claim 1, further comprising, prior to the step of deciding, a step of:
determining (S22) an occurrence frequency of the events specifically associated with the spatial location, based on the sensing data of the spatial location;
the step of deciding (S24) is performed further with reference to the determined occurrence frequency of the activity of the one or more objects.

11. The method according to claim 1, wherein the method further comprising, prior to the step of deciding (S24), a step of:
determining (S23) a time sequence of a plurality of events specifically associated with the spatial location, based on the sensing data of the spatial location;
the step of deciding (S24) is performed further with reference to the determined time sequence of the plurality of activities of the of the one or more objects.

12. The method according to claim 1, wherein the radar sensor is integrated into at least one lighting device deployed within the spatial location.

13. A processing system for adapting (S25) hold-on time of at least one lighting device deployed within a spatial location, the processing system being configured to:
determine (S21) occurrence of an event specifically associated with the spatial location by detecting an activity of one or more non-human objects involved in the event based on sensing data of the spatial location obtained by a radar sensor;
decide (S24) a type of the spatial location based on the occurrence of the event specifically associated with the spatial location; and
adapt (S25) the hold-on time of the at least one lighting device deployed within the spatial location based on the decided type of the spatial location,
wherein the processing system being configured to:
obtain (S31) a spectrogram representation of the sensing data of the spatial location by applying a transform algorithm to the sensing data;
identify (S32), in the spectrogram representation, an energy distribution pattern within predetermined frequency ranges representing the activity of one or more objects involved in the event; and
determine (S33) that the event specifically associated with the spatial location is present;
wherein hold on time comprises a duration between no occupant being detected and the lighting device being switched off or entering standby mode.

14. A lighting system comprising:
the processing system of claim 13;
a radar sensor; and
a light device;
wherein hold on time of the light device is adapted by the processing system based on the sensing data obtained by the radar sensor.

15. A computer program product, comprising a computer readable storage medium storing instructions which, when executed on at least one processor, cause said at least one processor to carry out the method according to claim 1.
